(19) United States
(12) Patent Application Publication
(10) Pub. No.: US 2014/0001386 A1
(43) Pub. Date: Jan. 2, 2014

(54) SOLENOID ACTUATED CONTROL VALVE DEVICE

(71) Applicant: Shih Fen CHUANG, Changhua (TW)

(72) Inventor: Shih Fen CHUANG, Changhua (TW)

(21) Appl. No.: 13/535,737

(22) Filed: Jun. 28, 2012

(51) Int. Cl. F16K 31/02

(52) U.S. Cl. 251/129.15

(57) ABSTRACT

A solenoid actuated control valve device includes a housing having a tubular member, a valve seat formed in the tubular member, a movable core engaged in the tubular member, a valve piece attached to the core and moved in concert with the core to engage with the valve seat, the valve piece includes a peripheral flange having an outer peripheral surface for engaging with the inner peripheral surface of the tubular member, and includes a peripheral groove formed in the peripheral flange for defining a peripheral flap and for flexibly or resiliently engaging with the inner peripheral surface of the tubular member, and the valve device includes a structure to be easily manufactured and effectively used for controlling the fluid media.

### BACKGROUND OF THE INVENTION

1. Field of the Invention

The present invention relates to a solenoid actuated control valve device, and more particularly to a solenoid actuated control valve device including a simplified structure to be easily and quickly manufactured and assembled and to be effectively used for switching or controlling the flowing of the fluid media.

2. Description of the Prior Art

Typical solenoid actuated control valve devices comprise a slidable or movable core slidably received or engaged in an outer coil or the like which may actuate or operate the core to selectively move or slide relative to the coil, in order to actuate or operate a movable valve piece to switch or control the flowing of the fluid media.

For example, U.S. Pat. No. 6,532,238 to Roman, and U.S. Pat. No. 7,222,636 to Nguyen et al. disclose two of the typical solenoid actuated control valve devices each also comprising a coil attached or mounted or secured or engaged onto an inner core for being energized to actuate or operate the core to selectively slide or move or actuate a valve piece to switch or control the flowing of the fluid media.

However, the typical solenoid actuated control valve devices comprise a complicated structure that may not be easily and quickly manufactured and assembled and that may be made with a complicated manufacturing procedure and with a greatly increased manufacturing cost.

The present invention has arisen to mitigate and/or obviate the afore-described disadvantages of the conventional solenoid actuated control valve devices.

### SUMMARY OF THE INVENTION

The primary objective of the present invention is to provide a solenoid actuated control valve device including a simplified structure to be easily and quickly manufactured and assembled and to be effectively used for switching or controlling the flowing of the fluid media.

In accordance with one aspect of the invention, there is provided a solenoid actuated control valve device comprising a housing including a tubular member having a bore formed in the tubular member and defined by an inner peripheral surface, the tubular member including a first end portion, and including an inlet port extended from the first end portion of the tubular member and communicative with the bore of the tubular member, and including an outlet port extended from the first end portion of the tubular member and communicative with the bore of the tubular member, and including a valve seat formed in the bore of the tubular member, a movable core slidably received and engaged in the bore of the tubular member, a valve piece attached to the movable core and moved in concert with the movable core and movable to selectively engage with the valve seat and to be selectively disengaged from the valve seat, the valve piece including a peripheral flange extended radially and outwardly therefrom and having an outer peripheral surface for movably engaging with the inner peripheral surface of the tubular member, and including a peripheral groove formed in the peripheral flange for defining a peripheral flap and for engaging with the inner peripheral surface of the tubular member, and a coil attached to the tubular member for selectively actuating the movable core and the valve piece to move relative to the tubular member.

The movable core includes a head provided thereon, and the valve piece includes a cavity formed therein for receiving and engaging with the head of the movable core. The movable core includes a pole extended outwardly therefrom and directed toward the valve seat, and the head is provided on the pole and includes an outer diameter greater than that of the pole, and the valve piece includes a channel formed therein and communicative with the cavity of the valve piece for receiving and engaging with the pole of the movable core and for anchoring the valve piece to the movable core.

The peripheral groove of the valve piece is preferably a V-shaped peripheral groove for forming a flexible and resilient peripheral flap. The inlet port includes an inner end portion extended into the bore of the tubular member for forming and defining the valve seat.

The housing includes a spring biasing member engaged with the movable core for biasing and moving the movable core relative to the tubular member or toward the valve seat. The housing includes a stationary core attached to the tubular member, and the spring biasing member is engaged between the movable core and the stationary core.

The stationary core includes an end plate attached to the housing. The housing includes two prongs extended from the housing and electrically connected to the coil, and the end plate includes two notches formed therein for receiving and engaging with the prongs respectively.

The housing includes a peripheral chamber formed and between a first fence and a second fence for receiving and engaging with the coil. The housing includes a peripheral space formed in the first fence, and two blocks engaged into the peripheral space of the first fence.

A container may further be provided and includes an inner compartment formed therein for receiving and engaging with the housing. The container includes an inner peripheral rib engaged with the first fence of the housing for anchoring the housing in the container. The container includes an end cover for retaining the housing in the container.

The housing includes a cap for selectively engaging with the inlet port and for selectively blocking and enclosing the inlet port, and/or includes another cap for selectively engaging with the outlet port and for selectively blocking and enclosing the outlet port when required.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a solenoid actuated control valve device in accordance with the present invention;

FIG. 2 is a cross sectional view of the solenoid actuated control valve device;

FIG. 3 is a cross sectional view similar to FIG. 2, illustrating the operation of the solenoid actuated control valve device;

FIG. 4 is a perspective view of a piston or valve piece of the solenoid actuated control valve device, in which a quarter of the piston or valve piece has been cut off for showing the inner structure of the piston or valve piece; and

FIG. 5 is an enlarged partial cross sectional view illustrating the operation of the solenoid actuated control valve device.

### DETAILED DESCRIPTION OF THE PREFERRED EMBODIMENT

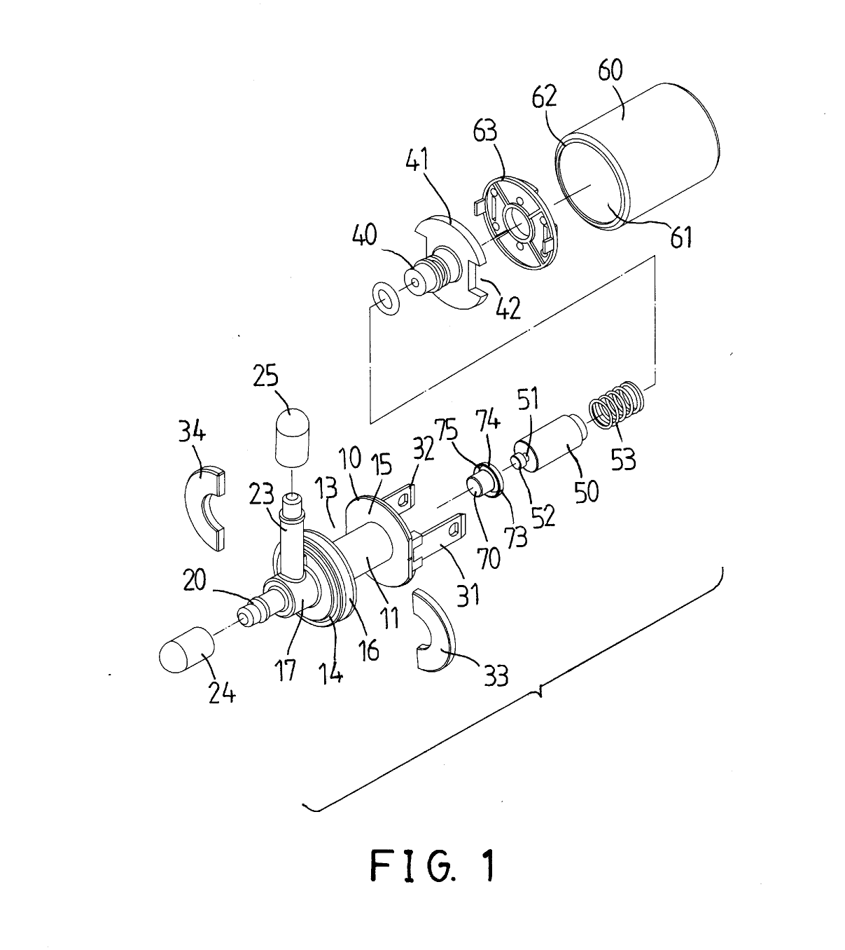

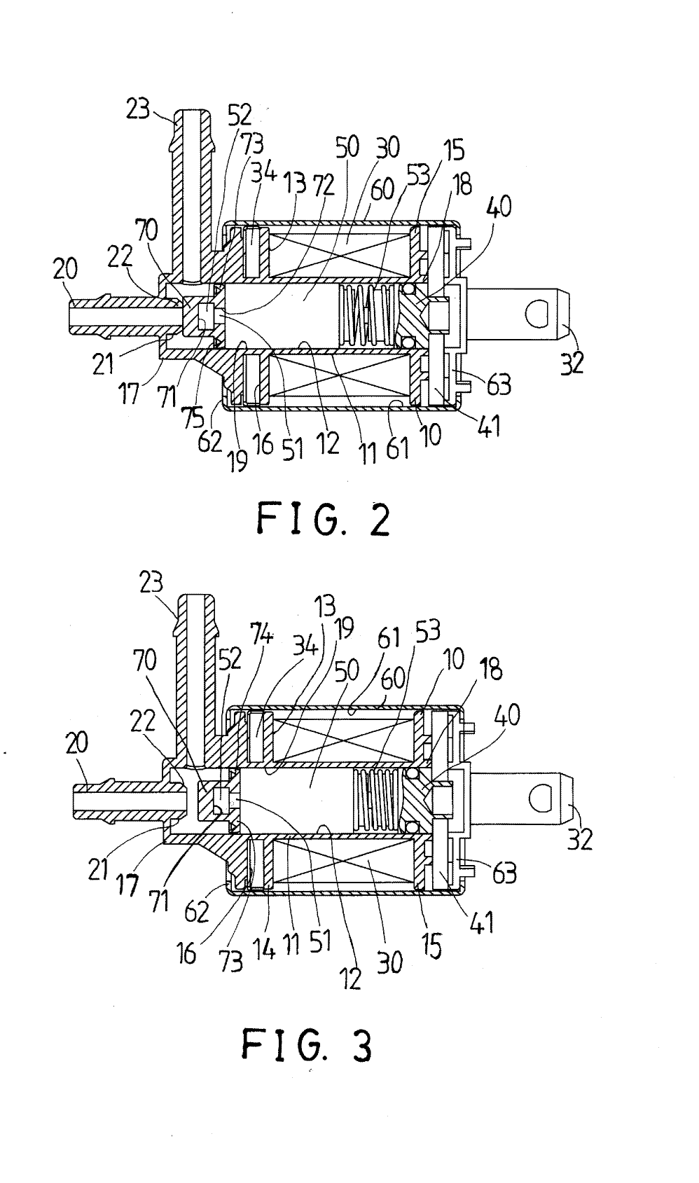

Referring to the drawings, and initially to FIGS. 1 and 2, a solenoid actuated control valve device in accordance with the present invention comprises a receptacle or housing 10 including a central cylindrical or tubular member 11 having a space or bore 12 formed therein and formed or defined by an inner peripheral surface 19, and having a peripheral recess or chamber 13 formed in the outer peripheral portion of the tubular member 11 and formed or defined between two fences 14, 15, and having a peripheral gap or slot or space 16 formed in one of the fences 14 and separated or offset from the peripheral chamber 13, in which the tubular member 11 includes one end or first end portion 17 extended out of the fence 14, and another end or second end portion 18 slightly or partially extended out of the other fence 15, best shown in FIGS. 2 and 3.

The housing 10 further includes an inlet port 20 attached or mounted or secured or coupled to or extended from the one end or first end portion 17 of the tubular member 11 and communicative with the bore 12 of the tubular member 11 for receiving water or air or fluid and for allowing the fluid to selectively flow into the bore 12 of the tubular member 11, it is preferable, but not necessarily that the inlet port 20 is parallel to or aligned or in line with the tubular member 11 and includes one end or inner end portion 21 extended into the bore 12 of the tubular member 11 for forming or defining a valve seat 22 in the bore 12 of the tubular member 11, and the housing 10 includes an outlet port 23 attached or mounted or secured or coupled to or extended from the one end or first end portion 17 of the tubular member 11 and communicative with the bore 12 of the tubular member 11 for allowing the fluid to selectively flow out of the one end or first end portion 17 of the tubular member 11.

The housing 10 may further include two covers or caps 24, 25 (FIG. 1) for selectively engaging with the inlet port 20 and the outlet port 23 and for selectively blocking or enclosing the inlet port 20 and the outlet port 23 respectively. A coil 30 (FIGS. 2, 3) is attached or mounted or secured or engaged into the peripheral chamber 13 of the housing 10, and includes one or more (such as two) prongs 31, 32 attached or mounted or secured to the housing 10, such as attached or mounted or secured to the other fence 15 of the housing 10 and electrically connected or coupled to the coil 30 for plugging and electrically connecting or coupling the coil 30 to the electrical power source (not shown) which may be used to energize and actuate or operate the coil 30. One or more (such as two) magnets or iron or ferrite plates or blocks 33, 34 may further be provided and disposed or attached or mounted or engaged into the peripheral gap or slot or space 16 of the fence 14 of the housing 10.

A fixed or stationary core 40 is provided and disposed or attached or mounted or engaged into the bore 12 at the other end or second end portion 18 of the tubular member 11 of the housing 10, and is attached or mounted or secured to the tubular member 11 and/or the housing 10 with an end plate 41 which is attached or mounted or secured to or extended from the stationary core 40 and which includes an outer diameter greater than that of the stationary core 40 for engaged with the other end or second end portion 18 of the tubular member 11 and/or the other fence 15 of the housing 10 and for attaching or mounting or securing to the other fence 15 of the housing 10 with adhesive materials, welders, latches or fasteners (not shown), or the like. The end plate 41 includes one or more (such as two) notches 42 formed therein for receiving or engaging with the prongs 31, 32 respectively.

A slidable or movable core 50 is slidably received or engaged in the bore 12 of the tubular member 11 of the housing 10, and includes a shaft or pole 51 extended outwardly therefrom and extended or directed toward the valve seat 22 and the inlet port 20, and an enlarged head 52 formed or provided on the pole 51 and having an outer diameter greater than that of the pole 51. A spring biasing member 53 is provided and disposed or engaged between the stationary core 40 and the movable core 50 for biasing and forcing or moving the movable core 50 toward the valve seat 22 and the inlet port 20. An outer sheath or container 60 may further be provided and disposed or attached or mounted or engaged onto the housing 10, or the container 60 includes an inner compartment 61 formed therein for receiving or engaging with the housing 10, and includes an inner peripheral flange or rib 62 extended from one end for engaging with the fence 14, and an outer or end cover 63 attached or mounted to the other end for solidly and stably and safely anchoring or confining or retaining the parts or elements and/or the housing 10 in the container 60.

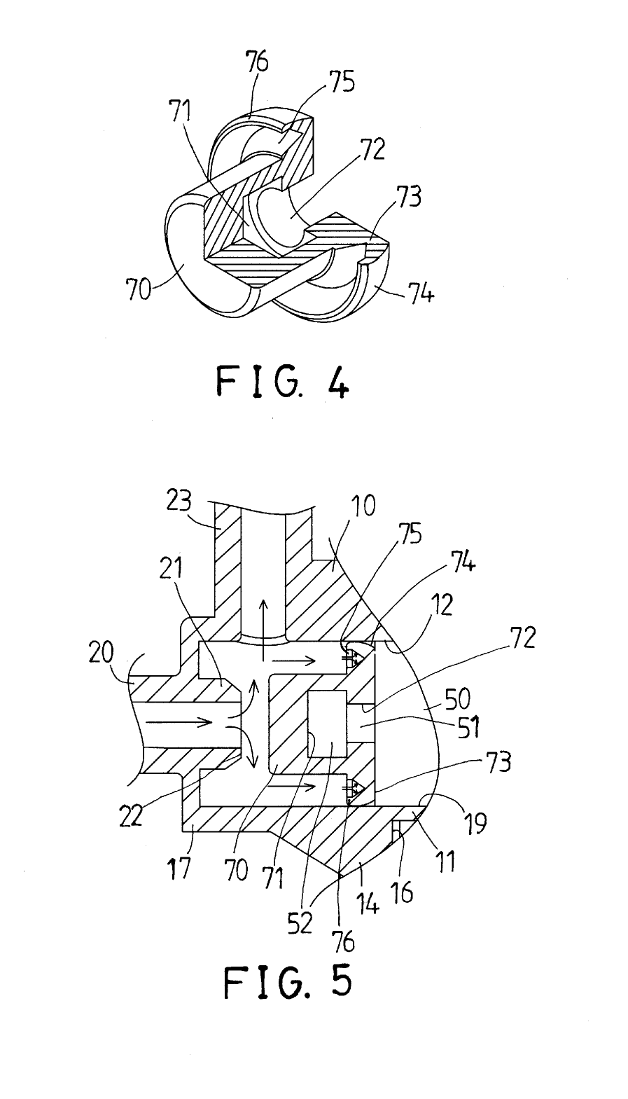

A piston or valve piece 70 is further provided and disposed or attached or mounted or engaged onto the head 52 of the movable core 50 (FIGS. 1-5), and includes a cavity 71 formed therein for receiving or engaging with the head 52 of the movable core 50, and includes a channel 72 formed therein and communicative with the cavity 71 of the valve piece 70 for receiving or engaging with the pole 51 of the movable core 50 and for solidly and stably attaching or mounting or anchoring or securing or retaining the valve piece 70 to the movable core 50 and for allowing the valve piece 70 to be moved or slid in concert with the movable core 50. The valve piece 70 includes a peripheral flange 73 extended radially and outwardly therefrom and having an outer peripheral portion or surface 74 for slidably and movably engaging with the inner peripheral surface 19 of the tubular member 11.

In operation, as shown in FIG. 2, for example, when the coil 30 is not energized or actuated or operated, the movable core 50 may be biased and forced or moved to engage with the inlet port 20 and/or the valve seat 22 with or by the spring biasing member 53, in order to block the inlet port 20 and to prevent the fluid from flowing into the bore 12 of the tubular member 11. On the contrary, as shown in FIG. 3, when the coil 30 is selectively energized or actuated or operated by the electrical power source (not shown), the movable core 50 may be forced or caused to move onto or toward the spring biasing member 53 and/or the stationary core 40 with or by the coil 30, and the piston or valve piece 70 may be forced or caused to move away from the inlet port 20 and/or the valve seat 22, and thus for allowing the fluid to selectively flow into the bore 12 of the tubular member 11 and then to selectively flow out through the outlet port 23 of the tubular member 11 or of the housing 10 (FIG. 5).

Alternatively, the spring biasing member 53 may also be selected from a compression spring biasing member 53 which may normally pull and disengage the piston or valve piece 70 from the inlet port 20 and/or the valve seat 22 (FIG. 3) for allowing the fluid to selectively flow into the bore 12 of the tubular member 11 and then to selectively flow out through the outlet port 23 of the tubular member 11 or of the housing 10, and the movable core 50 may be actuated and forced or moved or operated to selectively engage with the inlet port 20 and/or the valve seat 22 (FIG. 2) with or by the coil 30, such that the fluid media may also be switched or controlled by the selective engagement or disengagement of the piston or valve piece 70 from the inlet port 20 and/or the valve seat 22.

As best shown in FIGS. 2-5, the valve piece 70 further includes a peripheral groove 75, such as V-shaped peripheral groove 75 formed in the peripheral flange 73 and faced or opened or directed toward the inlet port 20 and/or the valve seat 22 for forming or defining a resilient outer peripheral lip or flap 76 and for suitably and frictionally engaging with the inner peripheral surface 19 of the tubular member 11 or of the housing 10, and thus for making a suitable and effective air or fluid tight seal between the piston or valve piece 70 and the tubular member 11 of the housing 10. It is to be noted that the piston or valve piece 70 is directly attached or mounted or secured to the movable core 50 and moved in concert with the movable core 50, and the resilient outer peripheral flap 76 of the peripheral flange 73 may suitably and frictionally and effectively engage with the inner peripheral surface 19 of the tubular member 11 or of the housing 10. The solenoid actuated control valve device includes a structure that may be easily and quickly manufactured and assembled with a complicated manufacturing procedure and with a greatly increased manufacturing cost, and that may be effectively used for switching or controlling the flowing of the fluid media.

Accordingly, the solenoid actuated control valve device in accordance with the present invention includes a simplified structure to be easily and quickly manufactured and assembled and to be effectively used for switching or controlling the flowing of the fluid media, and the valve piece includes a peripheral groove formed in a peripheral flange for flexibly or resiliently engaging with the inner peripheral surface of the tubular member.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A solenoid actuated control valve device comprising:
a housing including a tubular member having a bore formed in said tubular member and defined by an inner peripheral surface, said tubular member including a first end portion, and including an inlet port extended from said first end portion of said tubular member and communicative with said bore of said tubular member, and including an outlet port extended from said first end portion of said tubular member and communicative with said bore of said tubular member, and including a valve seat formed in said bore of said tubular member,
a movable core slidably received and engaged in said bore of said tubular member,
a valve piece attached to said movable core and moved in concert with said movable core and movable to selectively engage with said valve seat and to be selectively disengaged from said valve seat, said valve piece including a peripheral flange extended radially and outwardly therefrom and having an outer peripheral surface for movably engaging with said inner peripheral surface of said tubular member, and including a peripheral groove formed in said peripheral flange for defining a peripheral flap and for engaging with said inner peripheral surface of said tubular member, and
a coil attached to said tubular member for selectively actuating said movable core and said valve piece to move relative to said tubular member.

2. The solenoid actuated control valve device as claimed in claim 1, wherein said movable core includes a head, and said valve piece includes a cavity formed therein for receiving and engaging with said head of said movable core.

3. The solenoid actuated control valve device as claimed in claim 2, wherein said movable core includes a pole extended outwardly therefrom and directed toward said valve seat, and said head is provided on said pole and includes an outer diameter greater than that of said pole, and said valve piece includes a channel formed therein and communicative with said cavity of said valve piece for receiving and engaging with said pole of said movable core and for anchoring said valve piece to said movable core.

4. The solenoid actuated control valve device as claimed in claim 1, wherein said peripheral groove of said valve piece is a V-shaped peripheral groove.

5. The solenoid actuated control valve device as claimed in claim 1, wherein said inlet port includes an inner end portion extended into said bore of said tubular member for forming and defining said valve seat.

6. The solenoid actuated control valve device as claimed in claim 1, wherein said housing includes a spring biasing member engaged with said movable core for biasing and moving said movable core relative to said tubular member.

7. The solenoid actuated control valve device as claimed in claim 6, wherein said housing includes a stationary core attached to said tubular member, and said spring biasing member is engaged between said movable core and said stationary core.

8. The solenoid actuated control valve device as claimed in claim 7, wherein said stationary core includes an end plate attached to said housing.

9. The solenoid actuated control valve device as claimed in claim 8, wherein said housing includes two prongs extended from said housing and electrically connected to said coil, and said end plate includes two notches formed therein for receiving and engaging with said prongs respectively.

10. The solenoid actuated control valve device as claimed in claim 1, wherein said housing includes a peripheral chamber formed and between a first fence and a second fence for receiving and engaging with said coil.

11. The solenoid actuated control valve device as claimed in claim 10, wherein said housing includes a peripheral space formed in said first fence, and two blocks engaged into the peripheral space of said first fence.

12. The solenoid actuated control valve device as claimed in claim 10, wherein said housing includes two prongs extended from said second fence and electrically connected to said coil.

13. The solenoid actuated control valve device as claimed in claim 10 further comprising a container including an inner compartment formed therein for receiving and engaging with said housing.

14. The solenoid actuated control valve device as claimed in claim 13, wherein said container includes an inner peripheral rib engaged with said first fence of said housing for anchoring said housing in said container.

15. The solenoid actuated control valve device as claimed in claim 13, wherein said container includes an end cover for retaining said housing in said container.

16. The solenoid actuated control valve device as claimed in claim 1, wherein said housing includes a cap for selectively engaging with said inlet port and for selectively blocking and enclosing said inlet port.

17. The solenoid actuated control valve device as claimed in claim 1, wherein said housing includes a cap for selectively engaging with said outlet port and for selectively blocking and enclosing said outlet port.
